(19) United States
(12) Patent Application Publication
(10) Pub. No.: US 2025/0348716 A1
(43) Pub. Date: Nov. 13, 2025

(54) WEIGHT QUANTIZATION METHOD FOR ANALOG COMPUTING OF NEURAL NETWORK MODEL AND DEVICE FOR PERFORMING THE SAME

(71) Applicant: Intelligent HW, Inc., Lewes, DE (US)

(72) Inventors: Seok Man HONG, Seoul (KR); Hwan Jun ZANG, Seongnam-si (KR)

(21) Appl. No.: 19/203,755

(22) Filed: May 9, 2025

(30) Foreign Application Priority Data
May 10, 2024 (KR) 10-2024-0062150

(51) Int. Cl. G06N 3/0495; G06F 7/544

(52) U.S. Cl. CPC G06N 3/0495; G06F 7/5443

(57) ABSTRACT

An analog computing method for storing weights in non-volatile memory elements arranged in a memory array and performing a multiply-accumulate calculation (MAC) operation includes a quantization step for converting the weights, which are included in each of a plurality of layers for operations in a neural network model including the layers, from first weights represented in floating-point numbers to second weights by quantizing the first weights to fixed-point numbers or integers, a weight storage step in which the second weights are stored in the non-volatile memory elements arranged in the memory array, a MAC operation step in which an input signal is applied to the memory array to perform the MAC operation to output a MAC operation result, a digital conversion step in which the output MAC operation result is converted into a digital MAC operation result that is a digital signal.

### CROSS REFERENCE TO RELATED APPLICATION

The present application claims priority to Korean Patent Application No. 10-2024-0062150, filed on May 10, 2024, the entire contents of which are incorporated herein by reference for all purposes.

### BACKGROUND OF THE INVENTION

### 1. Field of the Invention

The present invention relates to a weight quantization method in analog computing of a neural network model and a device for performing the same, and in particular, to a quantization method and device characterized in that a plurality of quantization criteria are determined in one layer in quantizing weight data for analog computing in a neural network model.

### 2. Description of the Related Art

A human brain is composed of a number of neural cells called as neurons. Each of the neurons is connected to hundreds or thousands of other neurons through connection parts called as synapses. In order to imitate human intelligence, modeling the operation principle of biological neurons and the connection relationship between the neurons is called as an artificial neural network (ANN) model.

A deep neural network (DNN) is a type of the ANN and exhibits the excellent performance in various fields such as image recognition, speech recognition, natural language processing, a recommendation system, and the like. In particular, the performance of the DNN is continuously improved based on massive data and higher computation power, and has become a core technology in an artificial intelligence field.

Such a DNN is a neural network with several hidden layers between an input layer and an output layer. The DNN is composed of the input layer, the several hidden layers, and the output layer. Each of the layers is composed of a number of neurons (nodes), and neurons of adjacent layers are connected to each other. In such a DNN, input data is sequentially propagated in a direction from the input layer to the output layer. Each neuron receives an input from neurons of the previous layer, calculates a weighted sum, and transfers an output value obtained through an activation function to the next layer.

In order to implement such a DNN, a digital calculator using digital computing has been developed. The digital calculator exhibits high accuracy, but has problems of inevitable massive energy consumption due to limited parallel processing, memory barrier, or the like, and of application to various fields due to the large size, the consequent high price, or the like.

In order to overcome the problems, analog in-memory computing has been recently researched and developed which makes it possible to perform massive parallel processing in a method for storing the weights in non-volatile memories and performing MAC operations using the same, and to significantly reduce energy usage due to absence of energy barrier to enable production at a low cost.

Meanwhile, for matrix operations performed for DNN operations, it is required to quantize input data and weights. Raw data used for neural network operations may be, for example, 32-bit floating point (FP32)-type data or other different type data. However, for reducing data memory traffics and lightening operations, data used in each of the layers of the neural network may be required to be converted to a fixed-point or integer (INT4, INT8, or INT16) type. In this way, a technique for approximating data in a floating-point type to data in a fixed-point or integer type in order to reduce the data memory traffics and lighten the operations may be referred to as neural network quantization. Meanwhile, after completing the operations through quantized information, the resultant values may be dequantized back to the floating-point or fixed-point type data. The weight quantization is explained in Korean patent application laid-open No. 10-2024-0008816. However, such quantization is not for analog computing but for digital computing.

Such quantization in the analog computing is also required to be embodied in a different method from the digital computing. In particular, in the analog computing, a non-volatile memory array is included in an analog computing unit in which analog matrix operations are performed, and layer-wise weights according to a DNN model are stored in the non-volatile memory array. The weights stored in this way should be quantized as described above, and thus it is required to effectively develop such a quantization method.

### SUMMARY OF THE INVENTION

An object of the invention is to provide an efficient and highly accurate quantization method in analog computing, and an analog computing device for performing the same.

According to an embodiment of the invention, there is provided an analog computing method for storing weights in non-volatile memory elements arranged in a memory array and performing a multiply-accumulate calculation (MAC) operation, wherein the analog computing method may be characterized by including a quantization step for converting the weights, which are included in each of a plurality of layers for operations in a neural network model including the layers, from first weights represented in floating-point numbers to second weights by quantizing the first weights to fixed-point numbers or integers, a weight storage step in which the second weights are stored in the non-volatile memory elements arranged in the memory array, a MAC operation step in which an input signal is applied to the memory array to perform the MAC operation to output a MAC operation result, a digital conversion step in which the output MAC operation result is converted into a digital MAC operation result that is a digital signal, and a dequantization step for dequantizing the digital MAC operation result, wherein the quantization step is performed on each of two or more quantization unit groups set for the weights included in each of the layers of the neural network model, and the dequantization step is performed on the digital MAC operation result output for each of the quantization unit groups.

In addition, in the weight quantization method for performing analog computing according to an embodiment of the invention one of the quantization unit groups may be composed of weights stored in the memory elements arranged in one output line of the memory array.

In addition, in the weight quantization method for performing analog computing according to an embodiment of the invention, one of the quantization unit groups may be composed of weights included in one weight output channel included in the layer.

In addition, in the weight quantization method for performing analog computing according to an embodiment of the invention, the weights included in the one weight output channel may be stored in the memory elements arranged in one output line of the memory array.

In addition, in the weight quantization method for performing analog computing according to an embodiment of the invention, the weights included in the one weight output channel may be stored in the memory elements arranged in two or more output lines of the memory array.

In addition, in the weight quantization method for performing analog computing according to an embodiment of the invention, the quantization unit groups may be classified into positive quantization unit groups composed of positive values of the weights and negative quantization unit groups composed of negative values of the weights.

In addition, in the weight quantization method for performing analog computing according to an embodiment of the invention, a number of the positive quantization unit groups and the negative quantization groups may be two or more, and the weights included in one of the positive quantization unit groups and the negative quantization unit group may be included in a same output channel.

Meanwhile, an analog computing device may be characterized by including a memory array including non-volatile memory cells, a digital-to-analog converter (DAC) connected to an input terminal of the memory array, an analog-to-digital converter (ADC) connected to an output terminal of the memory array, and a scaler connected to receive an output of the ADC, wherein a unit of conversion of the scaler is adjustable for one output line or each of two or more output lines of the memory array.

According to the invention, the accuracy in analog computing may be improved.

### BRIEF DESCRIPTION OF THE DRAWINGS

FIG. 1 is a schematic view for explaining a process for performing MAC operations in analog computing;

FIG. 2 is a schematic view for explaining the entire analog MAC operation process;

FIG. 3 is a conceptual view for explaining deep neural network operation;

FIG. 4 is a conceptual view for explaining a fully-connected layer of a deep neural network;

FIG. 5 is a schematic view for explaining mapping of weight information to a memory array;

FIG. 6 is a schematic view for explaining mapping of weight information to a memory array;

FIG. 7 is a schematic view for explaining mapping of weight information to a memory array;

FIG. 8 is a conceptual view for explaining quantization;

FIG. 9 is a conceptual view for explaining quantization;

FIG. 10 is a conceptual view for explaining setting of a quantization unit group according to an embodiment of the invention;

FIG. 11 is a conceptual view for explaining setting of a quantization unit group according to an embodiment of the invention;

FIG. 12 is a conceptual view for explaining setting of a quantization unit group according to an embodiment of the invention;

FIG. 13 is a conceptual view for explaining setting of a quantization unit group according to an embodiment of the invention;

FIG. 14 is a conceptual view for explaining setting of a quantization unit group according to an embodiment of the invention;

FIG. 15 is a conceptual view for explaining setting of a quantization unit group according to an embodiment of the invention;

FIG. 16 is a conceptual view for explaining setting of a quantization unit group according to an embodiment of the invention;

FIG. 17 is a conceptual view for explaining setting of a quantization unit group according to an embodiment of the invention;

FIG. 18 is a conceptual view for explaining setting of a quantization unit group according to an embodiment of the invention;

FIG. 19 is a conceptual view for explaining setting of a quantization unit group according to an embodiment of the invention;

FIG. 20 is a conceptual view for explaining setting of a quantization unit group according to an embodiment of the invention; and

FIG. 21 is a schematic view for explaining operation results according to setting of a quantization unit group according to a comparative example and an embodiment of the invention.

### DETAILED DESCRIPTION OF THE EXEMPLARY EMBODIMENTS

Hereinafter, embodiments of the invention will be described in detail with reference to the accompanying drawings so that those skilled in the art can easily carry out the invention. It should be understood, however, that the invention may be embodied in many different forms and should not be construed as limited to the embodiments set forth herein.

Throughout the specification, unless explicitly described to the contrary, when an element is referred to as “comprising” or “including” a component, the word “comprising” or “including” will be understood to imply the inclusion of stated elements but not the exclusion of any other elements.

The terms “about or approximately” or “substantially” are used in a sense at or close to the numerical value when the manufacturing and material tolerances inherent in the stated meaning are presented, and to aid in the understanding of the invention. It is used to prevent an unconscionable infringer from using the mentioned disclosure in an unreasonable manner. As used throughout the specification, the term “step to” or “step of” does not mean “step for.”

Throughout the specification, the term “combination thereof” included in the expression of the Markush form means one or more mixtures or combinations selected from the group consisting of the components described in the expression of the Markush form. It is meant to include one or more selected from the group consisting of the components.

Throughout the specification, the term “A and/or B” means “A or B, or A and B”.

The invention relates to a method and device for effectively quantizing and dequantizing weights in analog in-memory computing.

An analog in-memory computing method is a method for storing weights in non-volatile memories and performing MAC operations using the same. Such analog in-memory computing is being researched and developed which makes possible the massive parallel processing to address memory barrier problems due to absence of external memories, thereby significantly reducing energy usage and enabling production at a low cost. Meanwhile, the analog computing in the invention means the analog in-memory computing.

As described above, in the analog MAC operations, the weight information is stored in the non-volatile memories in a memory array, and the MAC operations are performed at one time to output MAC operation results by inputting input signals to the memories.

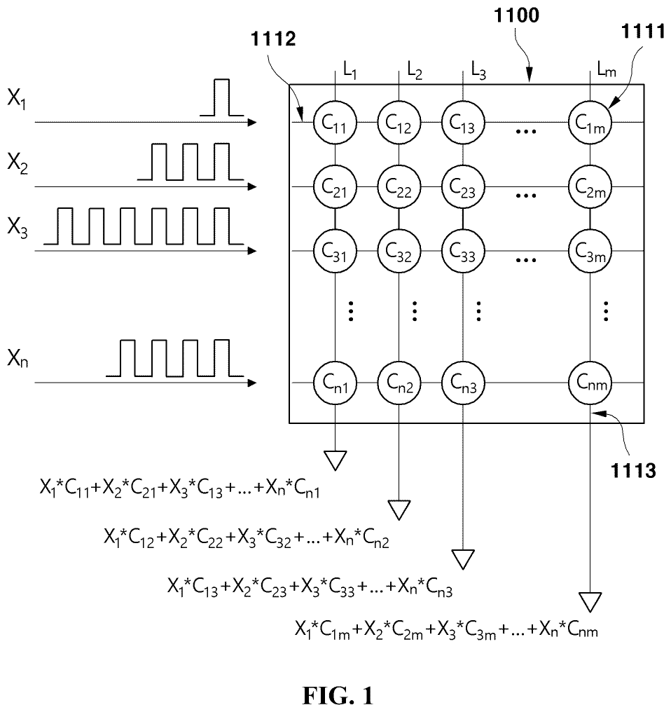

FIG. 1 explains such an analog MAC operation method. Input signals X₁, X₂, X₃, . . . , Xₙ are input from an input unit through input lines 1112 of the memory array 1100. Here, the input signals may be represented in the number of pulses with the same height and width, and various input signals may also be represented in not only the number of pulses but also a difference in pulse width or pulse height. Meanwhile, memory cells 1111 arranged in the memory array 1100 may store the weights through a change in resistance. Accordingly, as the input signals are applied through the resistance of various stages to the memory cells in which the weights are stored, current signals are output to be final MAC operation results.

More specifically, when the input signals X₁, X₂, X₃, . . . , Xₙ are applied to the memory cells C₁₁, C₂₁, C₃₁, . . . , Cₙ₁arranged in an output line L₁, the input signals are output as an output signal (X₁*C₁₁+X₂*C₂₁+X₃*C₁₃₊ . . . +Xₙ*Cₙ₁) in a current or voltage type through the output line L₁ through the respective memory cells, and output signals are also output from the remaining output lines L₂, L₃, . . . , Lₘ in the same manner. Finally, as the input signals input at the same time pass through the memory cells in which the weights are stored and the analog MAC operations are performed at a time, fast calculation with less energy consumption is enabled. The MAC operation results output in this way are analog signals represented in currents or voltages, and the results are digitized through an analog-to-digital converter ADC.

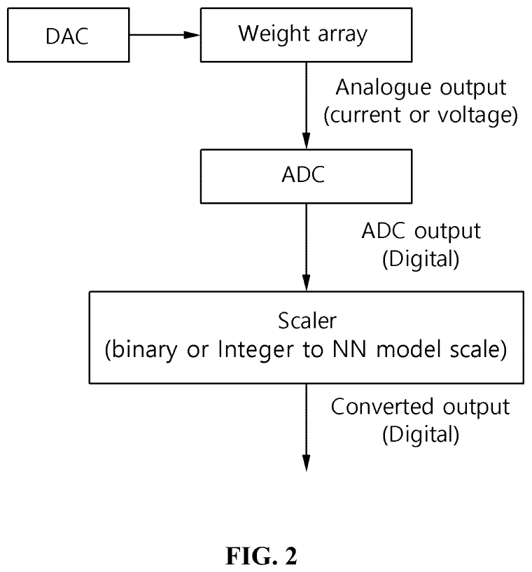

FIG. 2 is a conceptual view for explaining the entire analog MAC operation process. When the input signals are input to the memory array (weight array) through a digital-analog converter (DAC), the analog signals represented in currents or voltages are generated, the analog signals are converted into digital signals through the ADC to be de-quantized to floating-point data or fixed-point data through a scaler.

Meanwhile, the non-volatile memories forming the memory array may be flash memories. In particular, NOR flash memories among the flash memories may show a fast reading speed to be suitable for an inference-type artificial intelligence model.

Such a flash memory may not be a single level cell (SLC) for storing one-bit information, but be a multi-level cell (MLC), a triple level cell (TLC), or a quadruple level cell (QLC) that may store two or more bit-information, or be a memory element that may store more bits of information. The size of the memory array may be reduced by storing more information in one cell.

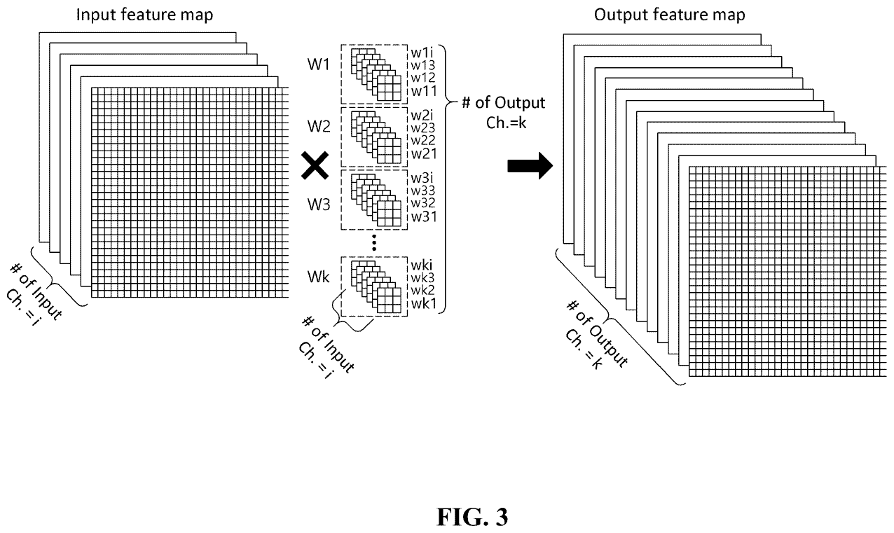

The operations through the DNN repeats an operation for outputting an output feature map through a convolution of an input feature map and the weights. The DNN may include a plurality of layers for the operations, and FIG. 3 is a conceptual view for explaining MAC operations performed in one layer. The input feature map includes I channels. Correspondingly, weight information may be stored in weight input channels each having, for example, a 3×3 unit matrix, and the number of the weight input channels may be I for each output channel, like the input feature map. Namely, for each output channel, there are I weight input channels in each of which the weights are stored in the 3×3 matrix, and there are k weight output channels. Accordingly, the number of final output feature maps is k like the number of the weight output channels.

More specifically, with reference to FIG. 3, a weight output channel W1 includes I weight input channels w11, w12, w13, . . . , w1i where I is the number of channels of the input feature map. In addition, the I weight input channels are included for each output channel, such as that a weight output channel W2 includes weight input channels w21, w22, w23, . . . , w2i, a weight output channel W3 includes weight input channels w31, w32, w33, . . . , w3i, or the like.

In the analog computing, such weights are stored in the memory array composed of non-volatile memory elements, and input signals corresponding to the input feature map are applied to the memory array to create an output feature map through signals output from the memory array.

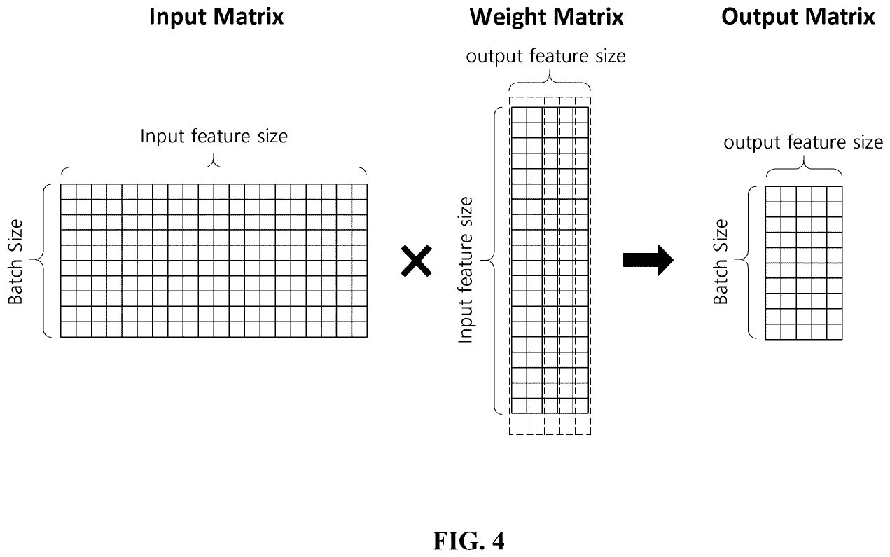

Meanwhile, the fully-connected layer among the layers included in the DNN performs convolution of one input matrix and one full-weight matrix without the weight input channels like in FIG. 3. FIG. 4 is a conceptual view for explaining the MAC operations performed in the fully-connected layer. Here, the number of columns of the output characteristics of the final output matrix may be determined according to the number of columns of the weight matrix. Accordingly, one column of the weight matrix means one weight output channel Wₐ, W_{b}, W_{c}, W_{d}, Wₑ.

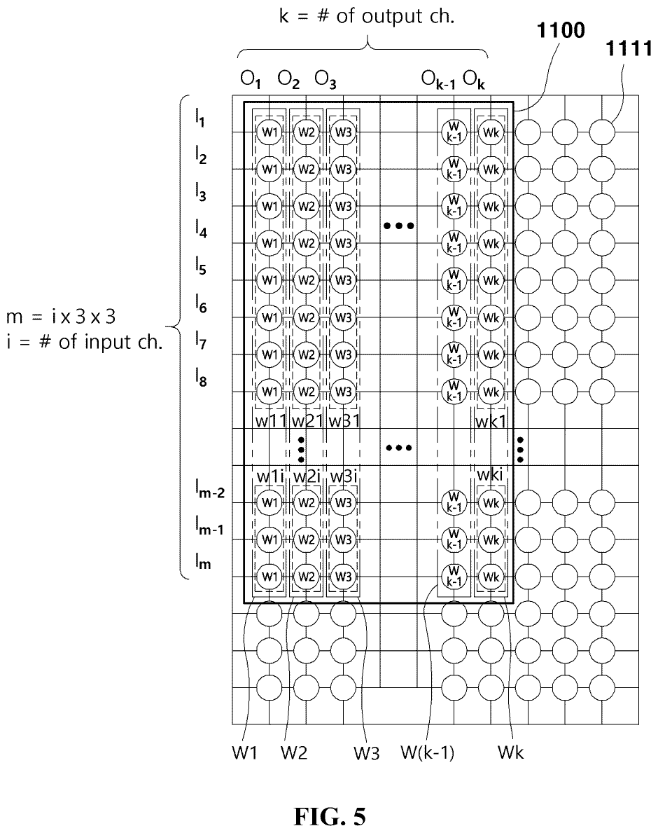

Such various pieces of weight information for each layer in the DNN are stored in the memory array, and physically storing the weight information in the memory array is referred to as mapping. FIG. 5 explains an example of mapping the weight information to the memory array according to FIG. 3 when one piece of weight information is stored in one memory element. The weights corresponding to the output channel W1 are consecutively stored in an output line O₁. Accordingly, the weights of the weight input channels w11, w12, w13, . . . , w1i included in the output channel W1 are consecutively stored in an output line O₁. Thereafter, the weights of the weight input channels w21, w22, w23, . . . , w2i included in the output channel W2 are consecutively stored in an output line O₂. As the weights are stored in this way, the overall weights corresponding to one layer are stored in memory elements 1111 of a region 1110 arranged across an input line (m=i×3×3) and an output line k in the memory array.

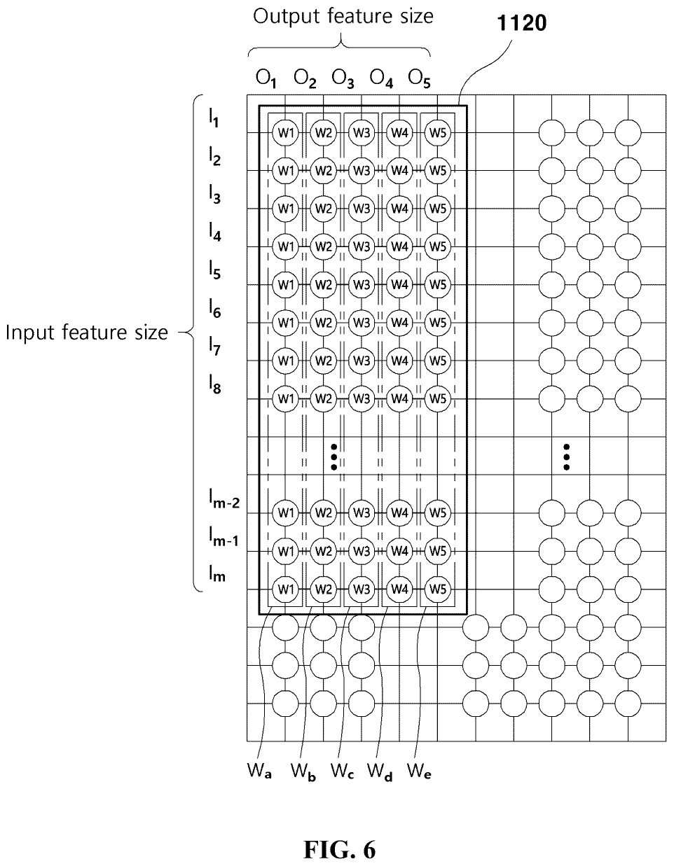

FIG. 6 shows mapping of weight information about the fully-connected layer as in FIG. 4. The weight information itself forms two dimension in the fully-connected layer, and thus the weight information according to the weight matrix are stored in the memory array as it is when one piece of the weight information is stored in one memory element. Accordingly, the weight information about the weight output channel Wₐ, W_{b}, W_{c}, W_{d}, Wₑ is stored in a region 1120 of the same size as the weight matrix in the memory array according to output lines O₁, O₂, O₃, O₄, O₅.

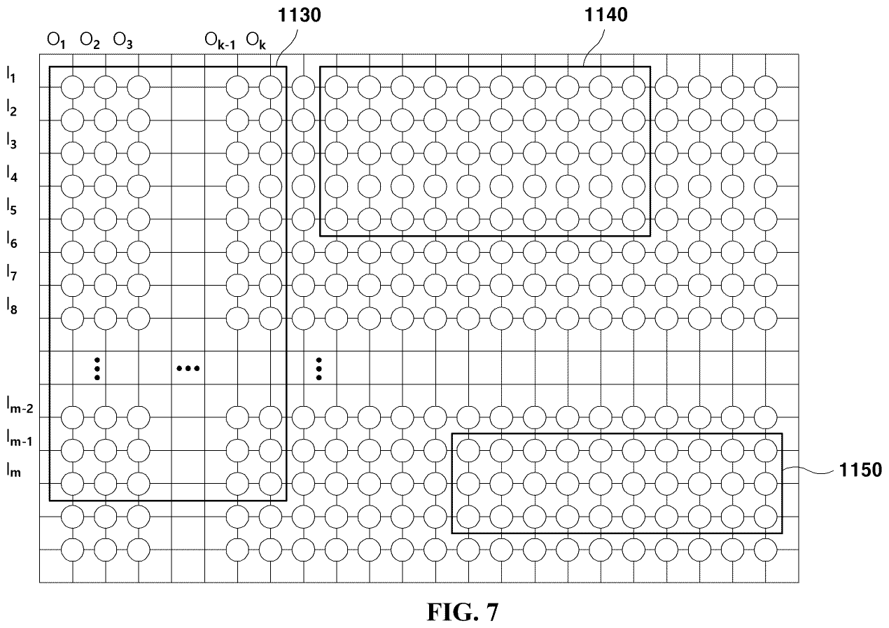

The region in which such weights are stored may not be one portion but several portions in the memory array. FIG. 7 shows that weights for each layer are stored in different regions 1130, 1140, and 1150 in the memory array. For example, the weights of a second layer may be stored in the region 1130, the weights of a third layer may be stored in the region 1140, and the weights of a fifth layer may be stored in the region 1150.

When the weights are stored in this way on the memory array, the weight information to be stored is required to be converted (quantized) from a floating-point type to fixed-point or integer (INT4, INT8, or INT16) type. When performing quantization in this way, a step for dividing data into multiple intervals in consideration of the entire data distribution and performing quantization for each interval is performed.

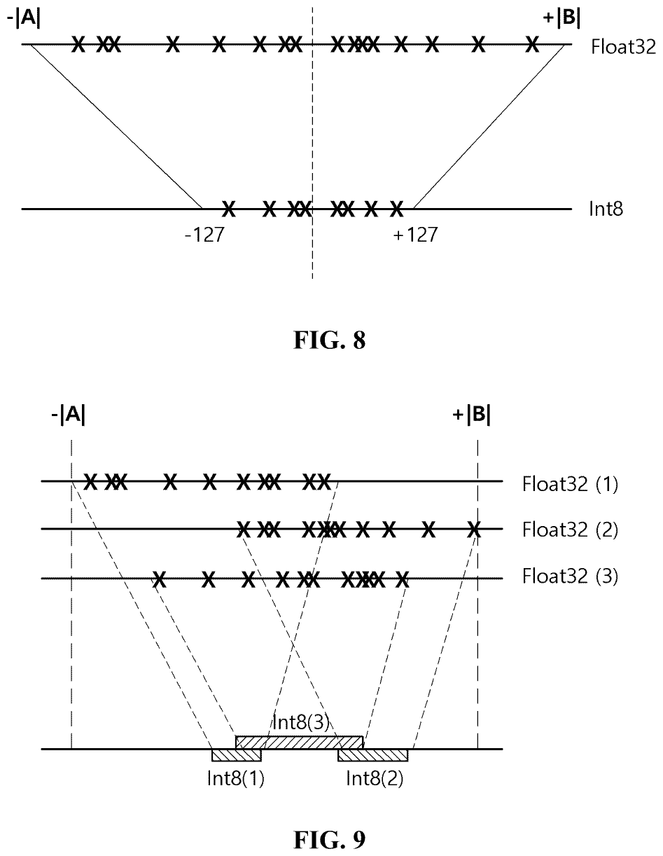

FIG. 8 is a conceptual view for explaining the quantization. Weights represented in the floating point type (Float32) are converted into quantized integers (Int8) to reduce the size of a model and a calculation cost. Here, in the past, a group of the whole floating-point data to be a base was the whole weights included in one layer. Namely, floating point data included in one layer is within a range of a constant interval (−|A| to +|B|) as in FIG. 8, and as such a range is larger, a quantization error may become larger.

In order to reduce such a quantization error of the weights, the invention does not quantize the overall weights included in one layer, but set a plurality of quantization groups of the overall weights in one layer and perform quantization according thereto.

FIG. 9 is a conceptual view for explaining formation of the plurality of quantization groups. The floating-point weights included in one layer are divided into three groups Float32(1), Float32(2), and Float32(3) to be converted to integers Int8(1), Int8(2), and Int8(3), and thus quantization may be performed within a narrow range to reduce the error.

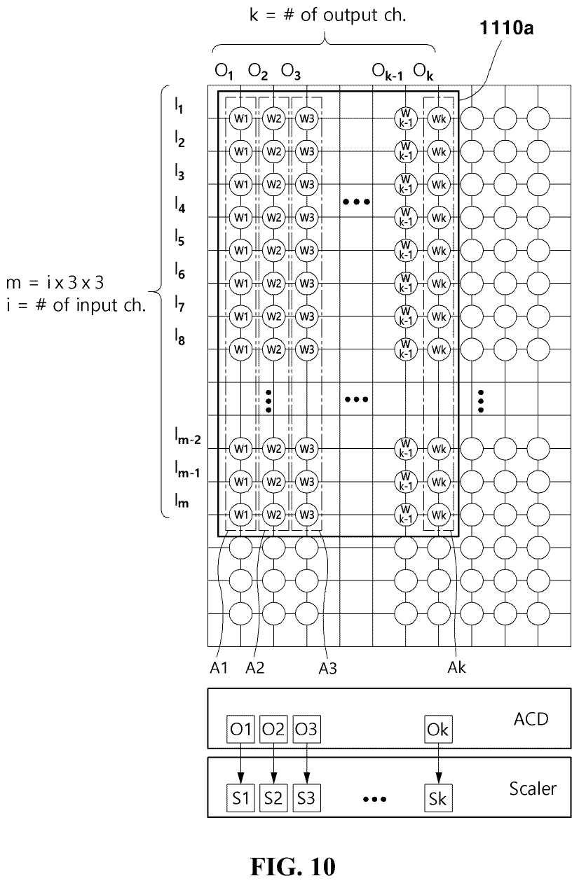

In an embodiment of the invention, it is preferable to classify the weights into the quantization groups on the basis of each output channel of the weights. FIG. 10 explains that when weights corresponding to one output channel are stored in one output line of the memory array as in FIG. 5, a weight quantization unit group is set for each output channel. The weights included in one layer are quantized to be stored in memory elements, and, here, the weights of the one output channel are stored in one output channel. Accordingly, weight information corresponding to the output channel W1 and stored in memory elements arranged in the output line O₁ is set as a quantization unit group A1, and weight information corresponding to the output channel W2 and stored in memory elements arranged in the output line O₂ is set as a quantization unit group A2. In this way, quantization groups A1, A2, A3, . . . , Ak are set and quantized for each output line.

Meanwhile, an ADC is disposed in a terminal of an output line and thus an output MAC operation result is digitized. An output signal is an analog signal and thus is digitized. The digitized value may be still represented in an integer or a fixed point number. Thus, the digitized value is required to be dequantized, and here the dequantization is also performed on the basis of a digital output signal output for each quantization unit group. Namely, a digital output signal O1 output through memory elements arranged in the memory array belonging to the quantization unit group A1 is dequantized according to a unit S1 of a scaler, and a digital output signal O2 output through memory elements arranged in the memory array belonging to the quantization unit group A2 is dequantized according to a unit S2 of the scaler.

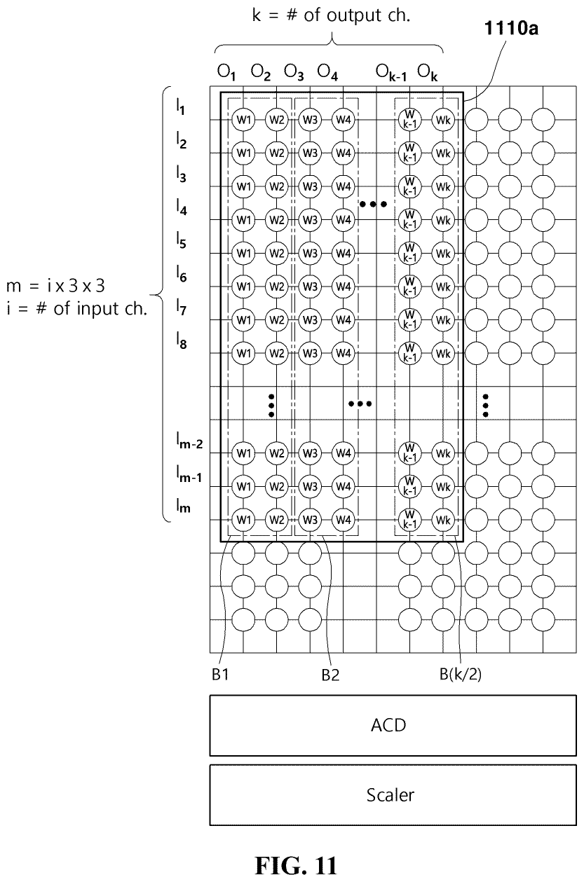

Meanwhile, the quantization unit groups in the memory array may be used as weights included in the plurality of weight output channels. FIG. 11 explains an embodiment in which two weight output channels are set to one quantization unit group. As in FIG. 5, when one weight output channel is stored in memory elements arranged in one output line, quantization is performed according to quantization unit groups B1, B2, . . . , B(k/2) stored in memory elements arranged in two output lines corresponding to two weight output channels, and thus an output MAC operation result may be dequantized. Thus, the quantization unit group B1 is composed of weight information corresponding to the weight output channel W1 and the weight output channel W2, and the quantization unit group B2 is composed of weight information corresponding to a weight output channel W3 and a weight output channel W4. Accordingly, the number of the quantization unit groups may be reduced by half (from k to k/2) in comparison to the embodiment according to FIG. 8.

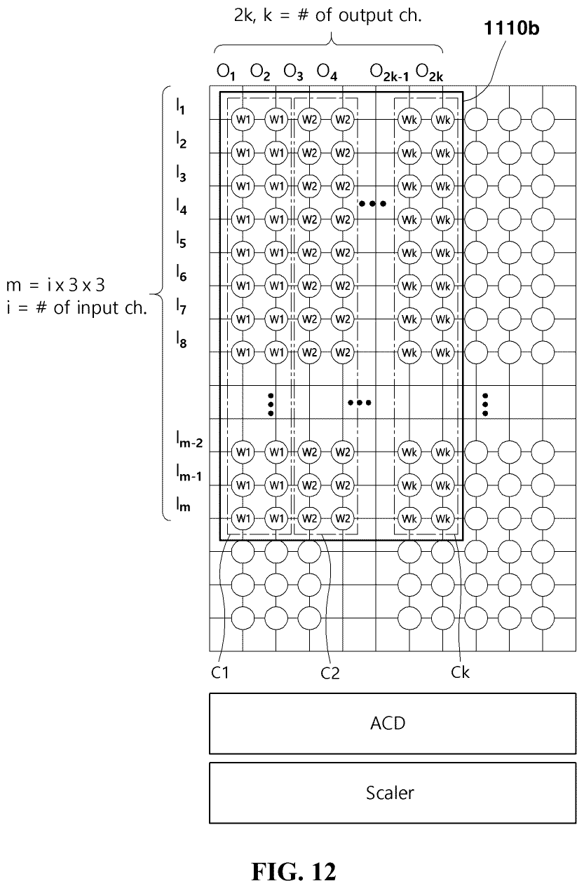

Weights included in one output channel in mapping of weights to the memory array may be mapped to two or more output lines of the memory array. FIG. 12 explains setting of a quantization unit group according to an embodiment of the invention, and represents a case in which, when weights corresponding to one layer are stored, one weight value is stored in not one but two memory elements. For example, one weight included in a kernel w11 included in the output channel W1 may be stored in memory elements arranged in the two output lines O₁ and O₂. For example, the memory elements are flash memory elements capable of storing 5-bit information and finally capable of storing 6-bit weight information when one weight is distributed to be stored in two memory elements. Preferably, it is efficient to store one weight in one memory element, but it may be typically difficult to store weight information represented with 8 bits in one memory element. Accordingly, one weight may be stored not in one but two memory elements. In this way, as weights corresponding to one output channel are stored in memory elements arranged in two output lines, one quantization unit group C1 may be based on weights stored in the memory elements arranged in the two output lines O₁, O₂. Here, weights included in the quantization unit groups C1, C2, . . . , Ck may be still based on weights included in respective output channels W1, W2, . . . , Wk. Accordingly, the whole weights corresponding to one layer may be stored in the memory elements 1111 in the area 1110b disposed across input lines (m=i×3×3) and output lines (2k) in the memory array.

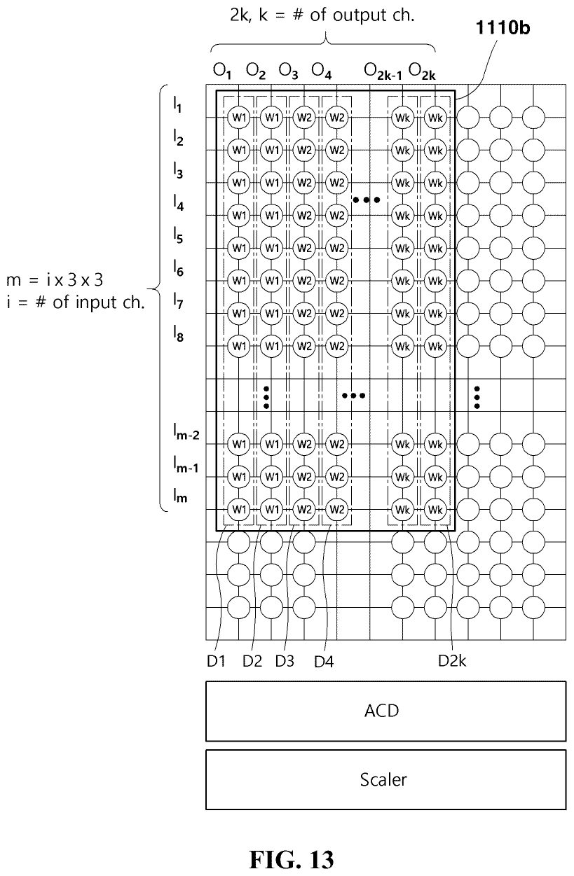

In mapping of weights to the memory array, even though weights included in one memory channel are mapped to two or more output lines of the memory array, a quantization unit may be defined for each output line of the memory array. FIG. 13 explains an example that even in a case in which, like FIG. 12, weights corresponding to one output channel are distributed to be stored in memory elements arranged in two output lines, the quantization unit is determined for each output line. Accordingly, among the weights corresponding to the same output channel W1, the weights stored in the memory elements arranged in the output line O₁ and the weights stored in the memory elements arranged in the output line O₂ may be set to different quantization unit groups D1 and D2.

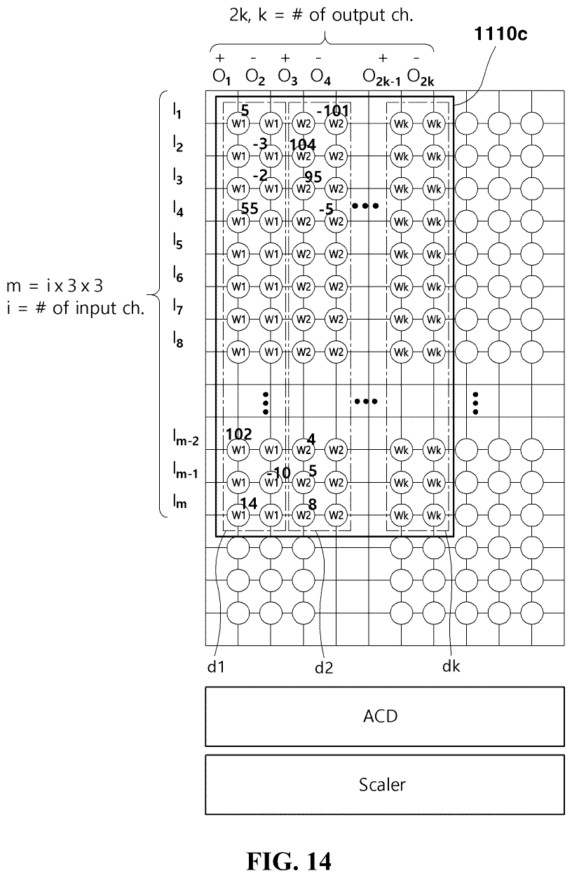

FIG. 14 explains setting of a quantization group according to an embodiment of the invention. When weights corresponding to one layer are stored, cases in which positive weight values and negative weight values are stored for each output line may be designated. The weights may be designated by mixing the positive weights and the negative weights. For example, when a weight is represented in 8 bits, values from 0 to 255 may be stored, but this may be mixed with negative weights to be represented as −127 to +127. Then the weights corresponding to one output channel may not be stored in one output line, but output lines O₁, O₃, . . . , O₂ₖ₋₁ stored with the positive weights and output lines O₂, O₄, . . . , O₂ₖ stored with the negative weights may be separately designated. Accordingly, the weights corresponding to one output channel may be distributed to be stored in a positive weight output line and a negative weight output line. Accordingly, one quantization unit group may be based on weights stored in memory elements arranged in two output lines of the memory array corresponding to one output channel. FIG. 14 shows that weights 5, −3, −2, 55, . . . , 102, −10, 14 corresponding to the one output channel W1 are distributed to be stored in the output lines O₁, O₂ corresponding to the one quantization unit group D1, and weights −101, 104, 95, 5, . . . , 4, 5, 8 corresponding to the one output channel W2 are distributed to be stored in the output lines O₃, O₄ corresponding to the quantization unit group D2. The positive weights among the weights corresponding to the quantization unit group W1 are stored in the output line O₁, and the negative weights are stored in the output line O₂. Similarly, the positive weights among the weights corresponding to the quantization unit group W2 are stored in the output line O₃, and the negative weights are stored in the output line O₄.

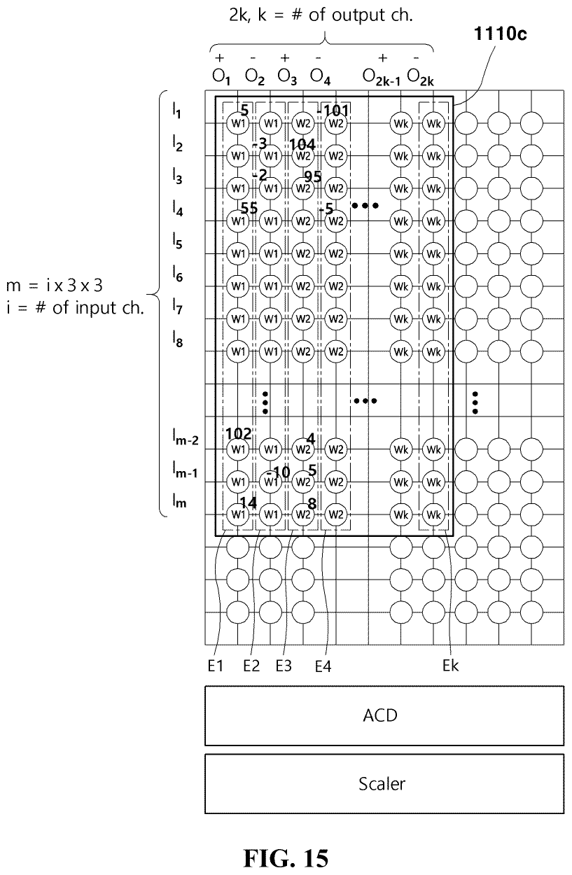

FIG. 15 explains an example that even in a case in which, like FIG. 14, weights corresponding to one output channel are distributed to be stored in memory elements arranged in two output lines, a quantization unit is determined for each output line. Accordingly, among the weights corresponding to the same output channel W1, weights stored in the memory elements arranged in the output line O₁ and weights stored in the memory elements arranged in the output line O₂ may be set to different quantization unit groups E1, E2. Accordingly, among the weights corresponding to the same output channel W2, weights stored in the memory elements arranged in the output line O₃ and weights stored in the memory elements arranged in the output line O₄ may be set to different quantization unit groups E3, E4.

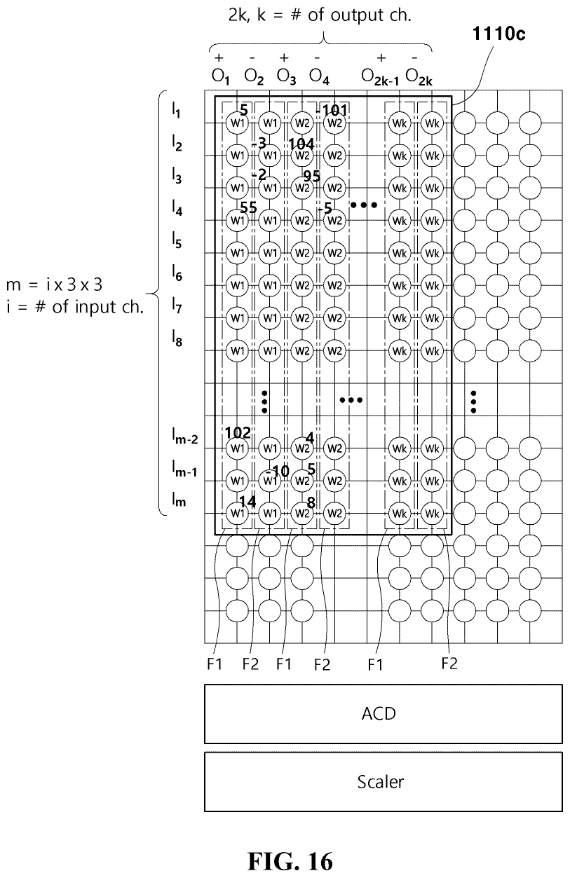

In addition, FIG. 16 describes a case in which, when weights are mapped in the same manner as shown in FIG. 14, positive weights and negative weights are distinguished from each other to be set to different quantization unit groups. Overall positive weights included in one layer may be set to a quantization unit group F1, and overall negative weights may be set to a quantization unit group F2. Accordingly, the positive weights are stored in the memory elements arranged in the output lines O₁, O₃, . . . , O₂ₖ₋₁ to be classified into the quantization unit group F1, and the negative weights are stored in the memory elements arranged in the output lines O₂, O₄, . . . ,O₂ₖ to be classified into the quantization unit group F2.

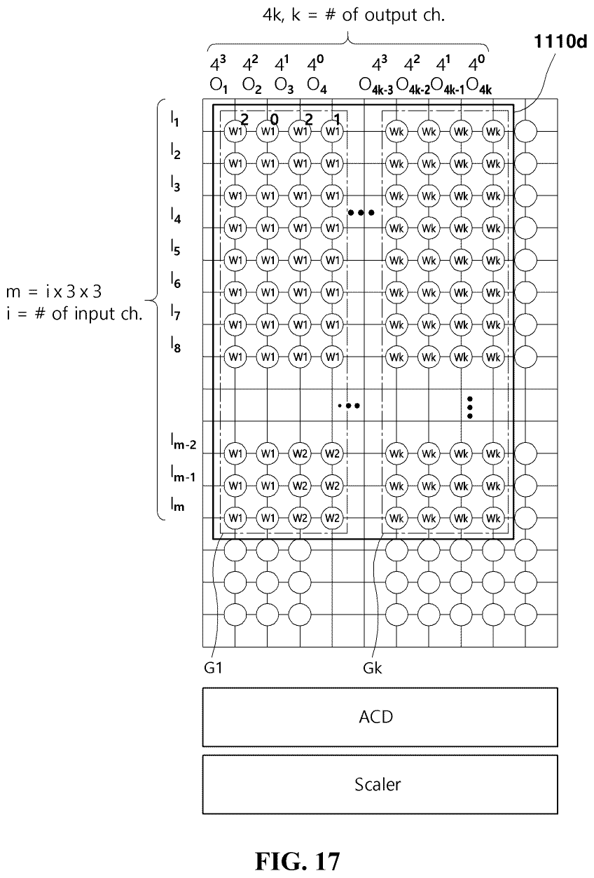

Meanwhile, in the weight mapping, one weight may also be stored in two or more memory elements corresponding to two or more output lines, and digital digits may also be designated to be stored for each output line. FIG. 17 represents a case in which one weight is stored in four memory elements that are MLCs. When the weight is represented through memory elements formed of an MLC capable of representing two-bit information, the weight may be represented through four output electrode lines 4⁰ to 4³ according to the quaternary number system. For example, +137, which is a weight to be quantized, may be represented as (2, 0, 2, 1) (namely, 4³*2+4²*0+4¹*2+4⁰*1=137) according to the digits to be stored in four memory elements arranged in the first input line I₁. Accordingly, a quantization unit group G1 may be composed of weights stored in memory elements arranged in the output lines O₁, O₂, O₃, O₄ corresponding to one output channel.

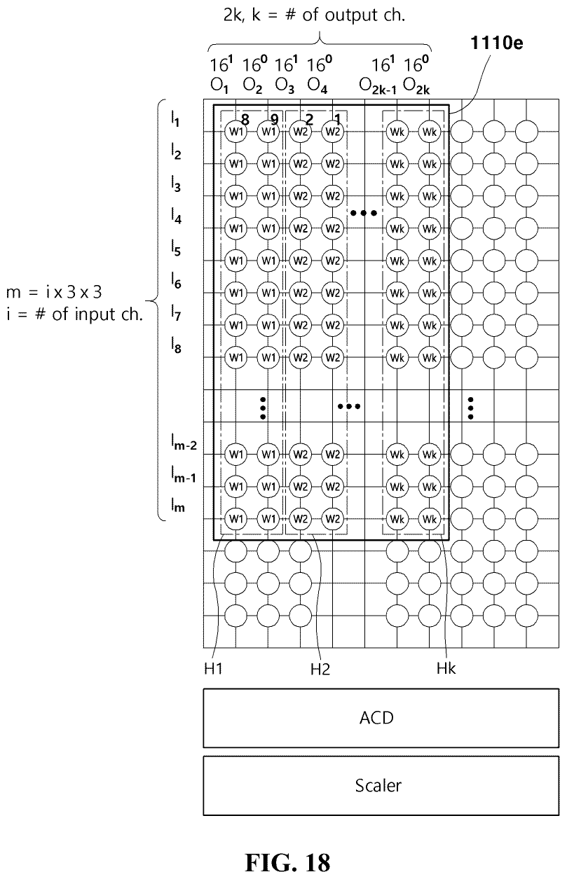

In addition, FIG. 18 represents a case in which, as one weight is stored in two memory elements that are QLCs, digital digits are stored for each output line. For example, when the first weight of the output channel W1 is +137, the first weight is represented as (8, 9) (namely, 16¹*8+16⁰*9=137) according to digits in two memory elements, weight +33 of the output channel W2 may be represented as (2, 1) (namely, 16¹*2+16⁰*1=33) according to the digits on two memory elements. Accordingly, a quantization unit group H1 may be composed of weights stored in memory elements arranged in the output lines O₁, O₂ corresponding to one output channel, and a quantization unit group H2 may be composed of weights stored in memory elements arranged in the output lines O₃, O₄ corresponding to one output channel.

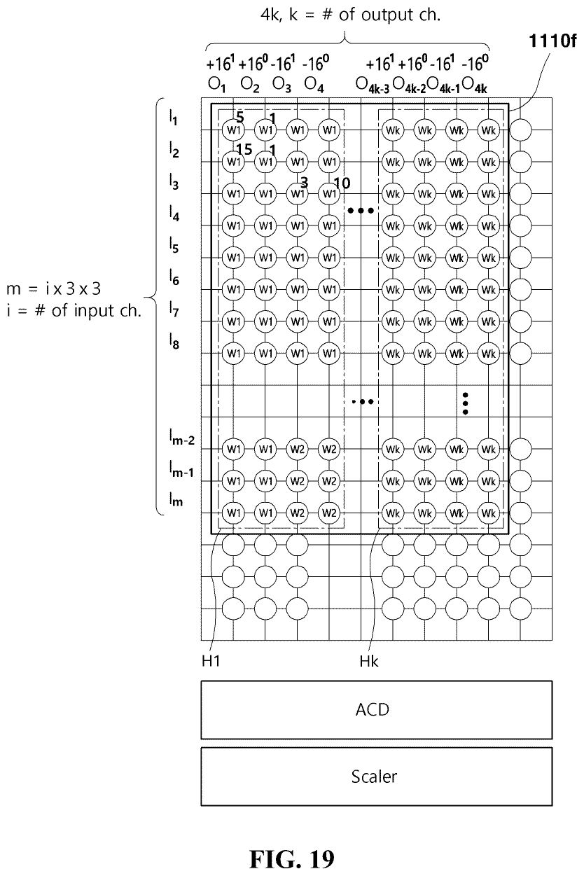

Meanwhile, FIG. 19 shows a case in which as one weight is stored in two memory elements that are QLCs, digital digits are stored for each output line, and a positive output line and a negative output line are designated. +81 may be represented as (5, 1) according to digits of memory elements arranged in the input line I₁ and the output lines O₁, O₂, +241 may be represented as (15, 1) according to digits of memory elements arranged in the input line 12 and the output lines O₁, O₂, and −58 may be represented as (3, 10) according to digits of memory elements arranged at the input line I₃ and the output lines O₃, O₄. Accordingly, the quantization unit group H1 may be composed of weights stored in memory elements arranged in output lines O₁, O₂, O₃, O₄ corresponding to one output channel.

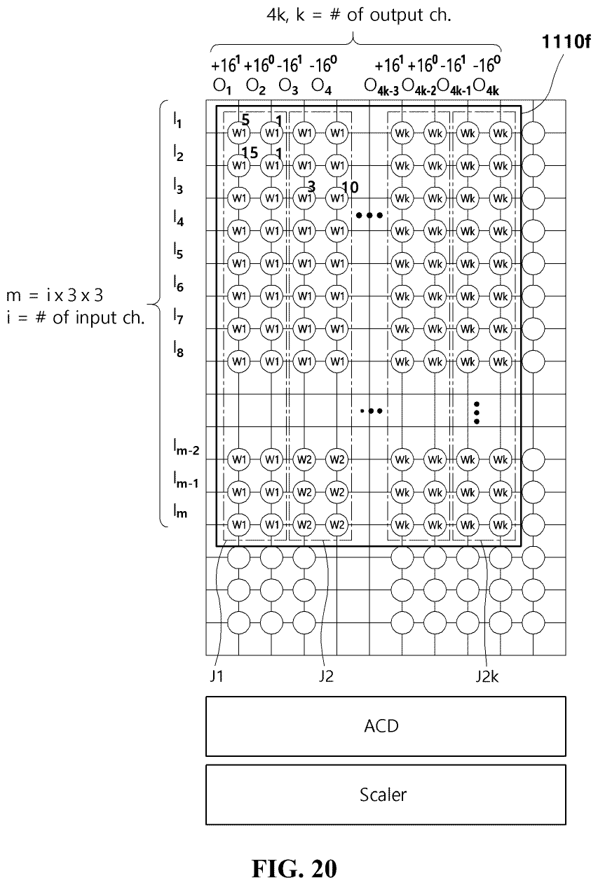

In addition, FIG. 20 describes a case in which, when weights are mapped in the same manner as in FIG. 19, the quantization unit groups for the positive weights are separately set from those for the positive weights. Accordingly, even the weights corresponding to the output channel W1 may be classified into a quantization unit group J1 according to positive weights stored in memory elements arranged in the output lines O₁, O₂, and a quantization unit group J2 according to negative weights stored in memory elements arranged in the output lines O₃, O₄.

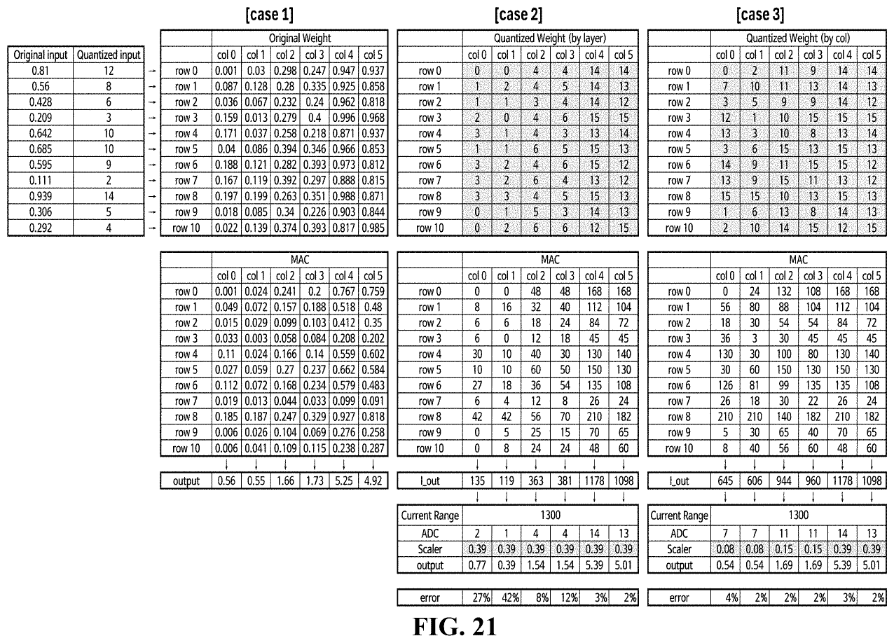

FIG. 21 describes MAC operation results according to such setting of the quantization unit groups. The first calculation result (case 1) shows a MAC operation result in a state where the weights are not quantized. The final result is shown in the lowest line (output).

The second calculation result (case 2) shows a result of calculation by setting the whole weights included in one layer to one quantization group. According to the described above, a unit of conversion of the scaler for dequantization is also equally set to 0.39 for all output lines. As a result, the maximum error appears 42%.

The third calculation result case 3 represents a result of setting weights stored in memory elements arranged in two output lines are set to one quantization unit group, subsequently quantizing the weights, and dequantizing the quantized result. The weights are quantized according to the quantization unit group, and the unit of conversion of the scaler for dequantizing the MAC operation result becomes different according to the quantization unit group. Accordingly, it may be seen that an error in the final result is significantly reduced in comparison to the second calculation (case 2).

What is claimed is:

1. A weight quantization method for performing analog computing for storing weights in non-volatile memory elements arranged in a memory array and performing a multiply-accumulate calculation (MAC) operation, the analog computing comprising:
a quantization step for converting the weights, which are comprised in each of a plurality of layers for operations in a neural network model comprising the layers, from first weights represented in floating-point numbers to second weights by quantizing the first weights to fixed-point numbers or integers;
a weight storage step in which the second weights are stored in the non-volatile memory elements arranged in the memory array;
a MAC operation step in which an input signal is applied to the memory array to perform the MAC operation to output a MAC operation result;
a digital conversion step in which the output MAC operation result is converted into a digital MAC operation result that is a digital signal; and
a dequantization step for dequantizing the digital MAC operation result,
wherein the quantization step is performed on each of two or more quantization unit groups set for the weights comprised in each of the layers of the neural network model, and the dequantization step is performed on the digital MAC operation result output for each of the quantization unit groups.

2. The weight quantization method for performing analog computing according to claim 1,
wherein one of the quantization unit groups is composed of weights stored in the memory elements arranged in one output line of the memory array.

3. The weight quantization method for performing analog computing according to claim 1,
wherein one of the quantization unit groups is composed of weights comprised in one weight output channel comprised in the layer.

4. The weight quantization method for performing analog computing according to claim 3,
wherein the weights comprised in the one weight output channel are stored in the memory elements arranged in one output line of the memory array.

5. The weight quantization method for performing analog computing according to claim 3,
wherein the weights comprised in the one weight output channel are stored in the memory elements arranged in two or more output lines of the memory array.

6. The weight quantization method for performing analog computing according to claim 1,
wherein the quantization unit groups are classified into positive quantization unit groups composed of positive values of the weights and negative quantization unit groups composed of negative values of the weights.

7. The weight quantization method for performing analog computing according to claim 6,
wherein a number of the positive quantization unit groups and the negative quantization groups is two or more, and the weights comprised in one of the positive quantization unit groups and the negative quantization unit group are comprised in a same output channel.

8. An analog computing device comprising:
a memory array comprising non-volatile memory cells;
a digital-to-analog converter (DAC) connected to an input terminal of the memory array;
an analog-to-digital converter (ADC) connected to an output terminal of the memory array; and
a scaler connected to receive an output of the ADC,
wherein a unit of conversion of the scaler is adjustable for one output line or each of two or more output lines of the memory array.
